(19) United States
(12) Patent Application Publication
(10) Pub. No.: US 2026/0238792 A1
(43) Pub. Date: Aug. 13, 2026

(54) PHASE-BASED CROSS-COMPONENT PREDICTION

(71) Applicant: InterDigital CE Patent Holdings, SAS, Paris (FR)

(72) Inventors: Edouard FRANCOIS, Bourg des Comptes (FR); Philippe BORDES, LAILLE (FR); Franck GALPIN, Thorigne-Fouillard (FR); Saurabh PURI, Saint-Lazare (CA)

(21) Appl. No.: 19/469,285

(22) PCT Filed: Apr. 22, 2024
(86) PCT No.: PCT/EP2024/060869

§ 371 Date: Sep. 25, 2025

(30) Foreign Application Priority Data
Apr. 25, 2023 (EP) 23315105.9

(51) Int. Cl. H04N 19/132; H04N 19/136; H04N 19/186

(52) U.S. Cl. CPC H04N 19/132; H04N 19/136; H04N 19/186

(57) ABSTRACT

Systems and methods are disclosed including techniques for encoding and decoding video data. The disclosed techniques include obtaining video data, including luma and chroma samples, and coding a chroma sample of the chroma samples. The coding of a chroma sample comprises deriving a phase-based model and then predicting the chroma sample using the phase-based model. The phase-based model is a function of a corresponding luma sample, a gradient, and a chroma phase. The disclosed techniques also include obtaining a bitstream that codes video data, including luma and chroma samples, and decoding a chroma sample of the chroma samples. The decoding of the chroma sample comprises deriving a phase-based model and then predicting the chroma sample using the phase-based model.

### CROSS REFERENCE TO RELATED APPLICATIONS

This application claims the benefit of European Application No. 23315105.9, filed on Apr. 25, 2023, which is incorporated herein by reference in its entirety.

### BACKGROUND

Cross-component based prediction techniques are used by a predictive encoder and decoder when predicting a chroma sample out of a corresponding luma sample. A cross-component based predictor applies a parametric model such as a convolutional cross-component model and related variants. The computational complexity of deriving these models and then applying them to the prediction of chroma samples depends on the model's number of parameters. The convolutional cross-component model and related variants use seven parameters and more. Hence, deriving and applying these models require solving seven-dimensional linear systems, including the inversion of a seven-dimensional autocorrelation matrix. A model with a smaller number of parameters can significantly reduce computational complexity, improve numerical stability, and reduce memory access times.

### SUMMARY

Aspects disclosed in the present disclosure describe methods for encoding video data. The methods include obtaining video data, including luma and chroma samples, and coding a chroma sample of the chroma samples. The coding of a chroma sample comprises deriving a phase-based model and then predicting the chroma sample using the phase-based model. The phase-based model is a function of a corresponding luma sample, a gradient of the corresponding luma sample, and a chroma phase. Aspects disclosed in the present disclosure also describe methods for decoding video data. The methods include obtaining a bitstream, coding video data including luma and chroma samples, and decoding a chroma sample of the chroma samples. The decoding of the chroma sample comprises deriving the phase-based model and then predicting the chroma sample using the phase-based model.

Aspects disclosed in the present disclosure describe apparatuses for encoding video data. The apparatuses comprise at least one processor and memory storing instructions. The instructions, when executed by the at least one processor, cause the apparatuses to obtain video data, including luma and chroma samples, and to code a chroma sample of the chroma samples. The coding of a chroma sample comprises deriving a phase-based model and then predicting the chroma sample using the phase-based model. The phase-based model is a function of a corresponding luma sample, a gradient of the corresponding luma sample, and a chroma phase. Aspects disclosed in the present disclosure also describe apparatuses for decoding video data. The apparatuses comprise at least one processor and memory storing instructions. The instructions, when executed by the at least one processor, cause the apparatuses to obtain a bitstream, coding video data including luma and chroma samples, and to decode a chroma sample of the chroma samples. The decoding of the chroma sample comprises deriving the phase-based model and then predicting the chroma sample using the phase-based model.

Further aspects disclosed in the present disclosure describe a non-transitory computer-readable medium comprising instructions executable by at least one processor to perform methods for encoding video data. The methods include obtaining video data, including luma and chroma samples, and coding a chroma sample of the chroma samples. The coding of a chroma sample comprises deriving a phase-based model and then predicting the chroma sample using the phase-based model. The phase-based model is a function of a corresponding luma sample, a gradient of the corresponding luma sample, and a chroma phase. Aspects disclosed in the present disclosure also describe a non-transitory computer-readable medium comprising instructions executable by at least one processor to perform methods for decoding video data. The methods include obtaining a bitstream, coding video data including luma and chroma samples, and decoding a chroma sample of the chroma samples. The decoding of the chroma sample comprises deriving the phase-based model and then predicting the chroma sample using the phase-based model.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of an example system, according to which aspects of the present embodiments can be implemented.

FIG. 2 is a functional block diagram of an example video encoder, according to which aspects of the present embodiments can be implemented.

FIG. 3 is a functional block diagram of an example video decoder, according to which aspects of the present embodiments can be implemented.

FIG. 4 is a diagram illustrating reference areas used for a cross-component based prediction, according to which aspects of the present embodiments can be implemented.

FIG. 5 is a diagram illustrating a multi-model cross-component based prediction, according to which aspects of the present embodiments can be implemented.

FIG. 6 is a flowchart for an example method for a cross-component based prediction, according to which aspects of the present embodiments can be implemented.

FIG. 7 is a flowchart illustrating the application of a phase-based model to cross-component based prediction, according to which aspects of the present embodiments can be implemented.

FIG. 8 is a diagram illustrating the relative positions of luma and chroma samples, according to which aspects of the present embodiments can be implemented.

FIG. 9 is a flowchart for an example method for encoding a chroma sample, according to which aspects of the present embodiments can be implemented.

FIG. 10 is a flowchart for an example method for decoding a chroma sample, according to which aspects of the present embodiments can be implemented.

### DETAILED DESCRIPTION

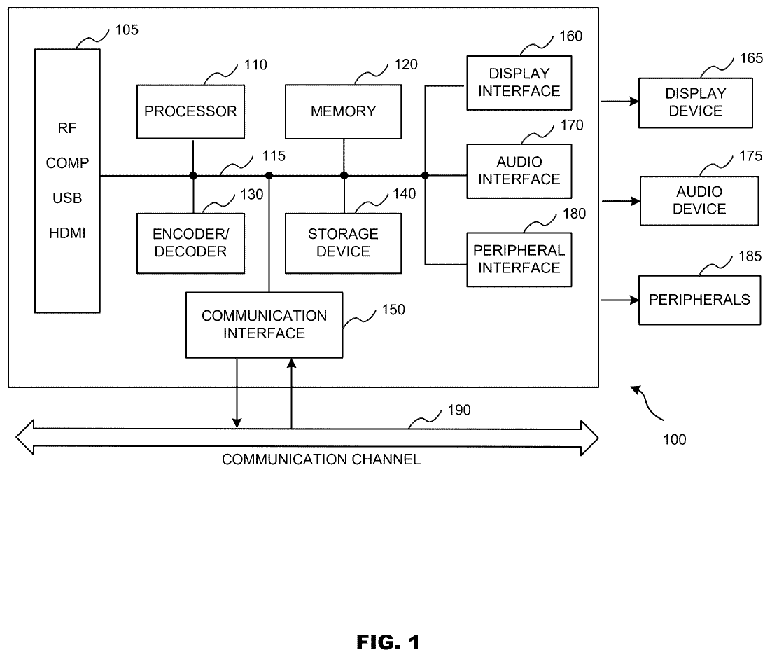

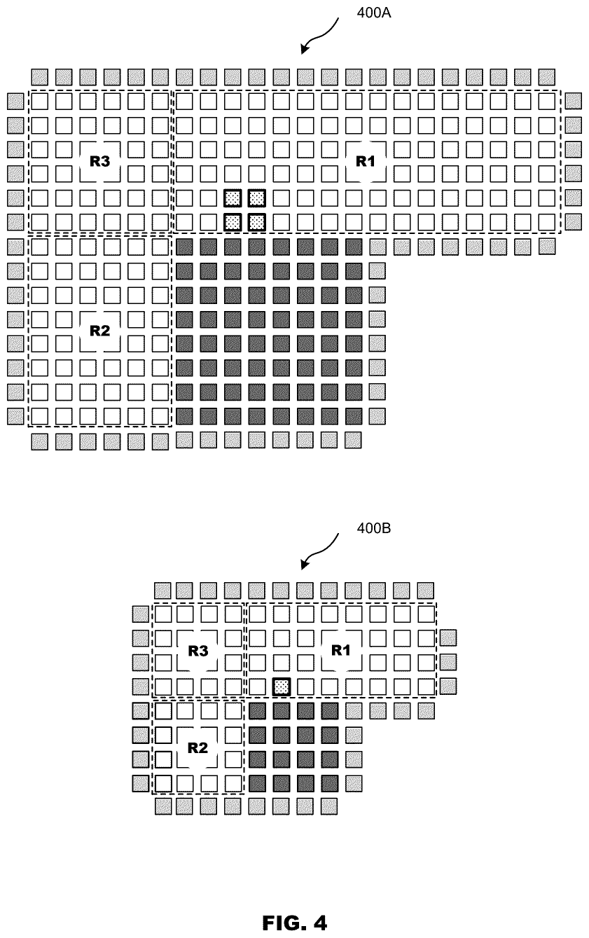

Systems and methods are disclosed herein for video encoding and video decoding. Aspects of the present disclosure describe techniques for reducing the computational complexity of deriving and applying models for cross-component based intra-prediction. Traditional systems and methods for predictive video coding are described next in reference to FIGS. 1-3, followed by description of aspects of the present disclosure, described in reference to FIGS. 4-10.

FIG. 1 illustrates a block diagram of an example system 100. System 100 can be embodied as a device and can be configured to perform one or more of the aspects described in this application. Examples of such devices, include, but are not limited to, various electronic devices such as personal computers, laptop computers, smartphones, tablet computers, digital multimedia set-top boxes, digital television receivers, personal video recording systems, connected home appliances, and servers. Elements of system 100, singly or in combination, can be embodied in an integrated circuit, multiple integrated circuits, and/or discrete components. For example, in at least one embodiment, the processing 110 and encoder/decoder 130 elements of system 100 are distributed across multiple integrated circuits and/or discrete components. In various embodiments, the system 100 is communicatively coupled to other systems, or to other electronic devices, via, for example, a communications bus or through dedicated input and/or output ports.

The system 100 includes at least one processor 110 that can be configured to execute instructions loaded therein for implementing, for example, the various aspects described in this application. Processor 110 can include embedded memory, input and output interfaces, and various other circuitries as known in the art. The system 100 includes at least one memory 120, such as a volatile memory device and/or a non-volatile memory device. System 100 includes a storage device 140, which can include non-volatile memory and/or volatile memory, such as EEPROM, ROM, PROM, RAM, DRAM, SRAM, flash, magnetic disk drives, and/or optical disk drives. The storage device 140 can be an internal storage device, an attached storage device, and/or a network accessible storage device, for example.

System 100 includes an encoder/decoder module 130 configured to process data to provide encoded video data or decoded video data. The encoder/decoder module 130 can include its own processor and memory. The encoder/decoder module 130 can be implemented as a separate element of system 100 or can be incorporated within processor 110 as a combination of hardware and/or software as known to those skilled in the art. Additionally, the encoder/decoder module 130 represents module(s) that can be implemented in a separate device to perform encoding and/or decoding functions.

Program code that is to be loaded into processor 110 or into encoder/decoder 130 to perform the various aspects described in this application can be stored in a storage device 140 and subsequently loaded into memory 120 for execution by processor 110. In accordance with various embodiments, one or more of processor 110, memory 120, storage device 140, and encoder/decoder module 130 can store one or more of various items during the performance of the processes described in this application. Such stored items can include, but are not limited to, the input video, the decoded video or portions of the decoded video, the bitstream, matrices, variables, operational logic, and intermediate or final results from the processing of equations, formulas, operations.

In several embodiments, memory inside of the processor 110 and/or the encoder/decoder module 130 is used to store instructions and to provide working memory for processing functions that are needed during encoding or decoding. In other embodiments, however, memory external to the processing device (where, for example, the processing device can be either the processor 110 or the encoder/decoder module 130) can be used for one or more of these functions. The external memory can be the memory 120 and/or the storage device 140 that may comprise, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 can be provided through various input devices as indicated in block 105. Such input devices include, but are not limited to, (i) an RF portion that receives an RF signal transmitted, for example, over the air by a broadcaster, (ii) a Composite input terminal (COMP), (iii) a USB input terminal, and/or (iv) an HDMI input terminal.

In various embodiments, the input devices of block 105 have associated respective input processing elements as known in the art. For example, the RF portion can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select, for example, a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements that perform these functions, for example, frequency selectors, signal selectors, band-limiters, channel selectors, filters, downconverters, demodulators, error correctors, and demultiplexers. The RF portion can include a tuner that performs some of these functions, including, for example, down-converting the received signal to a lower frequency (for example, an intermediate frequency or a near-baseband frequency) or to a baseband. In one set-top box embodiment, the RF portion and its associated input processing element receive an RF signal transmitted over a wired (for example, cable) medium, and perform frequency selection by filtering, down-converting, and filtering again to a desired frequency band. Various embodiments rearrange the order of the above-described (and other) elements, remove some of these elements, and/or add other elements performing similar or different functions. Added elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 100 to other electronic devices across USB and/or HDMI connections. It is to be understood that various aspects of input processing, for example, Reed-Solomon error correction, can be implemented, for example, within a separate input processing integrated circuit or within processor 110 as necessary. Similarly, aspects of USB or HDMI interface processing can be implemented within separate interface integrated circuits or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 can be provided within an integrated housing. Within the integrated housing, the various elements can be interconnected and transmit data therebetween using a suitable connection arrangement 115, for example, an internal bus as known in the art, including the I2C bus, wiring, and printed circuit boards.

The system 100 includes communication interface 150 that enables communication with other devices via communication channel 190. The communication interface 150 can include, but is not limited to, a transceiver configured to transmit and to receive data over communication channel 190. The communication interface 150 can include, but is not limited to, a modem or network card. The communication channel 190 can be implemented, for example, within a wired and/or a wireless medium.

Data can be streamed to the system 100, in various embodiments, using a Wi-Fi network such as IEEE 802.11. The Wi-Fi signal of these embodiments is received over the communication channel 190 and the communication interface 150 which can be adapted for Wi-Fi communications. The communication channel 190 of these embodiments is typically connected to an access point or router that provides access to outside networks including the Internet for allowing streaming applications and other over-the-top communications. In other embodiments, data can be streamed to the system 100 using a set-top box that delivers the data over the HDMI connection of the input block 105 or data can be streamed to the system 100 using the RF connection of the input block 105.

The system 100 can provide an output signal to various output devices, including a display device 165, an audio device (e.g., speaker(s)) 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display device 165, the audio device 175, or the other peripheral devices 185 using signaling such as AV.link, CEC, or other communication protocols that enable device-to-device control with or without user intervention. The output devices can be communicatively coupled to system 100 via dedicated connections through respective interfaces 160, 170, and 180. Alternatively, the output devices can be connected to system 100 using the communication channel 190 via the communication interface 150. The display device 165 and the audio device 175 can be integrated in a single unit with the other components of system 100 in an electronic device, for example, a television. In various embodiments, the display interface 160 includes a display driver, for example, a timing controller (T Con) chip.

Alternatively, the display device 165 and the audio device 175 can be separate from one or more of the other components, for example, if the RF portion of input 105 is part of a separate set-top box. In various embodiments in which the display device 165 and the audio device 175 are external components, the output signal can be provided via dedicated output connections, including, for example, HDMI ports, USB ports, or COMP outputs.

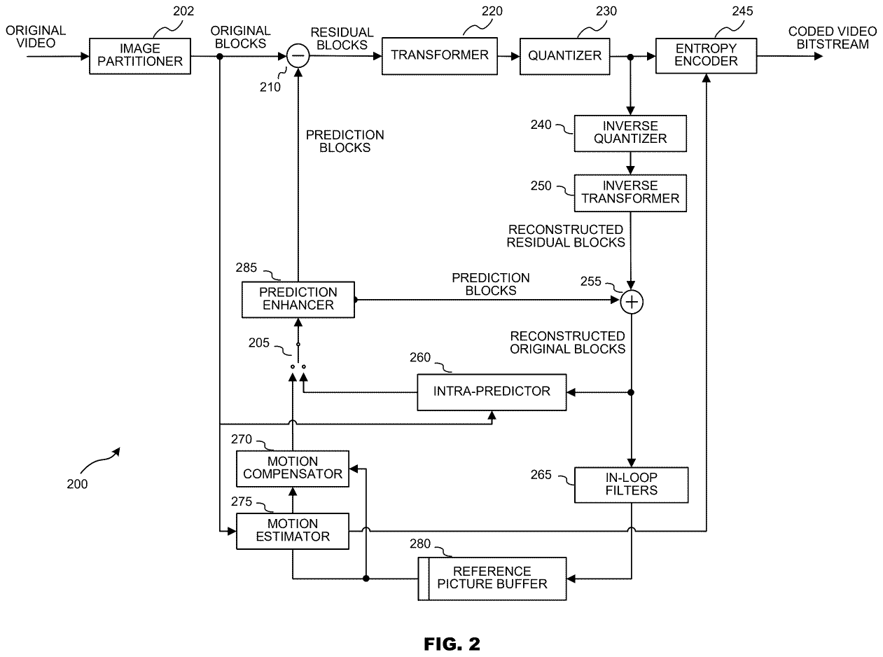

FIG. 2 illustrates a functional block diagram of an example video encoder 200. The video encoder 200 can be employed by the system 100 described in reference to FIG. 1. For example, the video encoder 200 can be an encoder that operates according to coding standards such as Advanced Video Coding (AVC, H.264/MPEG-4|ISO/IEC 14496-10), High Efficiency Video Coding (HEVC, ITU-T H.265|ISO/IEC 23008-2), or Versatile Video Coding (VVC, Standard ITU-T H.266, ISO/IEC 23090-3, 2020).

Prior to undergoing encoding, the video data can be pre-processed by a precoding processor (not shown). Such pre-processing can include applying a color model transform to the color components of the input video frames (e.g., conversion from RGB 4:4:4 to YCbCr 4:2:0) or mapping the color components of the input video frames to obtain a signal distribution that is more resilient to compression (for instance, applying a histogram equalizer and/or a denoising filter to one or more of the video frames' color components). The pre-processing can also include associating metadata with the video data that can be attached to the coded video bitstream.

In the encoder 200, a video frame is encoded by the encoder elements as generally described below. A picture (frame) of the original video to be encoded is partitioned into coding units(namely, original blocks) by an image partitioner 202. Typically, a coding unit (CU) contains a luminance block and respective chroma blocks, and so, generally, operations described herein as applied to a CU are applied to the luminance block and to the respective chroma blocks. Following partition 202, each CU can be encoded using an intra-prediction mode or an inter-prediction mode. In an intra-prediction mode, a prediction of the CU is performed by an intra-predictor 260. In the intra-prediction mode, the content of a CU in a frame is predicted based on content from one or more other CUs of the same frame, using the other CUs' reconstructed version (available from the adder 255 output). In an inter-prediction mode, motion estimation and motion compensation are performed by a motion estimator 275 and a motion compensator 270, respectively. In the inter-prediction mode, the content of a CU in a frame is predicted based on content from one or more other CUs of neighboring frames, using the other CUs' reconstructed versions (available from the reference picture buffer 280). The encoder decides 205 which prediction result (one obtained through operations in the intra-prediction mode 260 or one obtained through operations in the inter-prediction mode 270, 275) to use for encoding a CU, and indicates the selected prediction mode by a prediction mode flag, for example. The selected prediction result may then be enhanced (e.g., filtered) by a prediction enhancer 285, outputting a respective prediction block. Once a prediction block is generated for each CU, a respective residual block is calculated, for example, by subtracting 210 the predicted CU (i.e., prediction block) from the CU (i.e., original block).

A CU's respective residual block or a partition thereof (i.e., a transform block) is then transformed into a coefficient block by a transformer 220—that is, residual samples of the transform block are transformed into transform coefficients of the coefficient block. The resulting coefficient block is quantized by a quantizer 230. An entropy encoder 245 is next employed to entropy-encode the quantized coefficient block and respective coding parameters (e.g., syntax elements including motion vectors and other control data). Hence, the entropy-encoded quantized coefficient blocks and respective encoding parameters associated with each video frame of the original video are packed into the bitstream of the coded video data.

Along with the coding of original blocks (CUs), as described above, the encoder 200 reconstructs the coded original blocks to provide references for future predictions. Accordingly, quantized coefficient blocks (provided by the quantizer 230) are de-quantized, by an inverse quantizer 240, and then inverse transformed, by an inverse transformer 250, to reconstruct (decode) the residual blocks of respective original blocks. Adding 255 the reconstructed residual blocks to respective prediction blocks results in respective reconstructed original blocks. In-loop filters 265 can then be applied to the reconstructed picture (formed by the reconstructed original blocks), performing, for example, deblocking filtering and/or sample adaptive offset (SAO) filtering to reduce encoding artifacts. The filtered reconstructed picture can then be stored in the reference picture buffer 280, available for future predictions in an inter-prediction mode. Thus, the encoder 200 also performs decoding operations 240, 250 through which the encoded pictures (frames) are reconstructed. The reconstructed pictures can then be stored in the reference picture buffer 280 and be used to facilitate motion estimation 275 and compensation 270, as explained above.

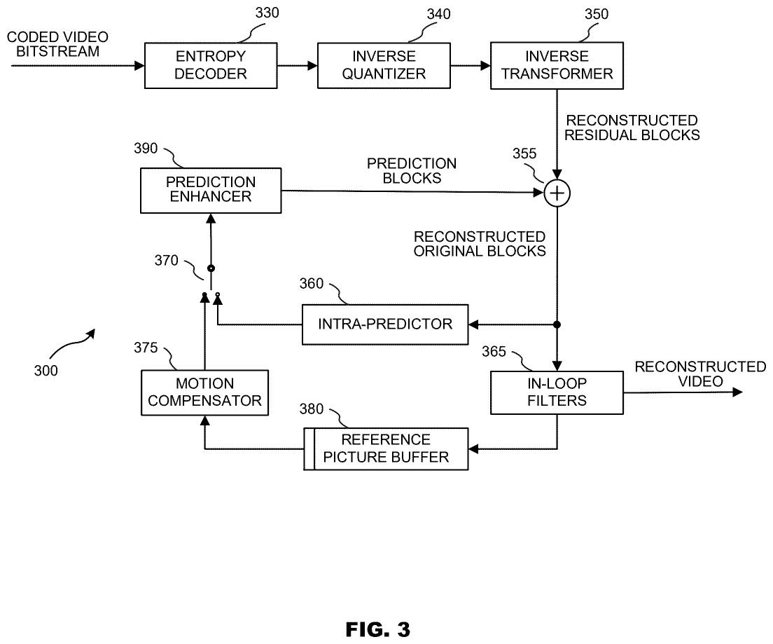

FIG. 3 illustrates a functional block diagram of an example video decoder 300. The video decoder 300 can be employed by the system 100 described in reference to FIG. 1. Generally, operational aspects of the video decoder 300 are reciprocal to operational aspects of the video encoder 200. In the decoder 300, the bitstream of coded video data, generated by the video encoder 200, is first entropy-decoded by an entropy decoder 330, decoding from the bitstream the quantized coefficient blocks and various coding parameters. The quantized coefficient blocks are de-quantized, by an inverse quantizer 340, and then are inverse transformed, by an inverse transformer 350, to decode (reconstruct) respective residual blocks. Adding 355 the reconstructed residual blocks to respective prediction blocks results in respective reconstructed original blocks. Depending on the selected prediction mode, a predicted original block can be obtained 370 from an intra-predictor 360 or from a motion compensator 375 and may then be enhanced (e.g., filtered) by a prediction enhancer 390, generating a prediction block. In-loop filters 365 can be applied to the reconstructed picture (formed by the reconstructed original blocks), outputting a reconstructed (decoded) video frame. The filtered reconstructed picture is also stored in a reference picture buffer 380 to facilitate motion compensation 375.

A post-decoding processor (not shown) can further process the reconstructed video. For example, post-decoding processing can include an inverse color model transform (e.g., conversion from YCbCr 4:2:0 to RGB 4:4:4) or an inverse mapping to reverse the mapping process performed by the pre-encoding processor. The post-decoding processor can use metadata that were derived by the pre-encoding processor and/or were signaled in the video bitstream.

Aspects disclosed herein are described in reference to a CU, however, the described aspects are similarly applicable to any region of the video frame (i.e., video data region) that intra-prediction can be applied to by an encoder 260 or a decoder 360. Generally, aspects described herein may be applied to a video data region, formed by a video partition, of any shape or size. A CU includes a luma component, Y, and chroma components, Cr and Cb (either one of which is referred to herein also by C). Typically, a chroma component C is subsampled, and, so, has a reduced resolution relative to the corresponding luma component Y.

As mentioned above, the encoder 200 may select 205 to encode the video data of a CU based on the prediction result(s) outputted from the intra-predictor 260. Generally, the image content of a chroma component C is correlated with the image content of the corresponding luma component Y and its close spatial neighborhood. To take advantage of such cross-component correlation, approaches exist that predict a chroma sample (from a chroma component C) based on the corresponding luma sample (from the corresponding reconstructed luma component Yᵣ) and, possibly, based on neighboring luma samples. Several of these approaches, generally referred to herein as cross-component (CC) based predictions, apply models that are described below—including cross-component linear model (CCLM), convolutional cross-component model (CCCM), gradient and location based convolutional cross-component model (GL-CCCM), and related variants.

A CCLM is a model for a CC-based prediction, where chroma samples from the C component of a CU (that is coded in an intra-prediction mode) are linearly predicted based on respective luma samples from the reconstructed and subsampled Y component of the CU, denoted Yᵣₛ. Thus, the linear prediction of a chroma sample at a pixel location (i,j), that is, a chroma sample C(i,j), can be expressed as follows:

$${C}_{p}^{CCLM} ( i , j ) = α \cdot {Y}_{r s} ( i , j ) + β , \qquad ( 1 )$$

$$where , {C}_{p}^{C C L M} ( i , j )$$

indicates a predicted chroma sample at a pixel location (i,j), and Yᵣₛ(i,j) indicates a corresponding luma sample at the pixel location (i,j). The parameters α and β of the linear model shown in equation (1) can be estimated, for example, based on reference samples and by using a least-squares optimization algorithm that finds the parameters α and β that minimize the model's sum of squared errors. The model's error can be formulated as follows:

$$E ( n ) = {c}_{r e f} ( n ) - ( α \cdot {y}_{r e f} ( n ) + β ) , n ∈ 1 : N , \qquad ( 2 )$$

where, a pair of y_{ref}(n) and c_{ref}(n) indicates, respectively, a reference luma sample and a corresponding reference chroma sample, indexed by n∈1:N. And, where a pair of y_{ref}(n) and c_{ref}(n) reference samples are derived, respectively, from reconstructed luma and chroma samples that are in the vicinity of the CU for which the prediction is performed (according to equation (1)). Hence, a least-squares optimization algorithm finds the optimal values for α and β that minimize the sum of squared errors

$$E = {\sum }_{n = 1}^{N} {E ( n )}^{2} .$$

The N pairs of reference samples —that is, pairs (y_{ref}(n), c_{ref}(n)) for n∈1:N, can be selected from a reference area, as further explained with reference to FIG. 4.

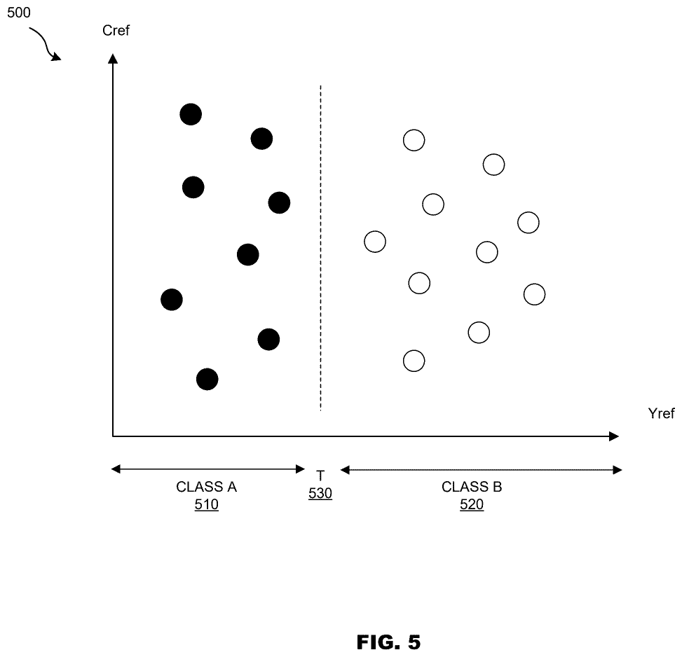

Several variants to CCLM exist. The variation can be with respect to 1) the location and/or the number N of the reference pairs used to estimate the model's parameters α and β; 2) the method for estimating the model's parameters; or 3) the type of filter that is used when down-sampling the reconstructed luma component Yᵣ into its down-sampled version Yᵣₛ. For example, when an Enhanced Compression Model (ECM) is used (see, M. Coban, et al., “Algorithm description of Enhanced Compression Model 4 (ECM 4),” document JVET-Y2025, 23rd Meeting, by teleconference, 7-16 Jul. 2021), the CCLM included in the VVC is extended by adding three multi-model linear model (MMLM) modes (see, K. Zhang, et al., “Enhanced Cross-component Linear Model Intra-prediction,” document JVET-D0110). A multi-model CC-based prediction is described below with respect to FIG. 5.

A CCCM is another model for a CC-based prediction (see, P. Astola, et al., “AHG12: Convolutional cross-component model (CCCM) for intra prediction,” document JVET-Z0064, 26th Meeting, by teleconference, 20-29 Apr. 2022). Similar to CCLM, a CCCM can be used to predict chroma samples based on corresponding subsampled reconstructed luma samples. Also, similar to CCLM, there is an option of using a single model or a multi-model variant of CCCM, as described with respect to FIG. 5. Preferably, a multi-model CCCM should be selected when a large number of reference pairs are available (e.g., N≥128).

The parameters of a CCCM include a 3×3 kernel K, a nonlinear term p, and a bias term b. The kernel K is a plus sign shaped kernel, having kernel coefficients k_{C}, k_{N}, k_{S}, k_{W}, and k_{E} that are situated, respectively, at the center, north, south, west, and east of the pixel location that the kernel is convolved with. For example, applying the kernel K to a luma sample Yᵣₛ(i,j), the convolution result, Yᵣₛ(i,j)*K, is:

$${Y}_{rs} ( i , j ) * K = {Y}_{rs} ( i , j ) \cdot {k}_{C} + {Y}_{rs} ( i , j - 1 ) \cdot {k}_{N} + {Y}_{rs} ( i , j + 1 ) \cdot {k}_{S} + {Y}_{rs} ( i - 1 , j ) \cdot {k}_{W} + {Y}_{rs} ( i + 1 , j ) \cdot {k}_{E} . \qquad ( 3 )$$

The nonlinear term p can be determined as the power of two of Yᵣₛ(i,j) that is scaled to the used bit depth. For example, for a bit depth of 10 bits, the nonlinear term p can be:

$$p ≡ P ( {{Y}_{rs} ( i , j )}^{2} ) = ( {{Y}_{rs} ( i , j )}^{2} + 512 ) ≫ 10. \qquad ( 4 )$$

The bias term b can be determined as the middle chroma value (e.g., 512 for 10-bit content).

Hence, prediction of a chroma sample based on a CCCM model can be expressed as follows:

$${C}_{p}^{CCCM} ( i , j ) = {Y}_{rs} ( i , j ) * K + α \cdot P ( {{Y}_{rs} ( i , j )}^{2} ) + β \cdot b , where {C}_{p}^{CCCM} ( i , j ) \qquad ( 5 )$$

indicates a predicted chroma sample at a pixel location (i,j) and where Yᵣₛ(i,j) indicates a corresponding luma sample at a pixel location (i,j). Note that

$${C}_{p}^{CCCM} ( i , j )$$

can be further clipped to the range of the chroma sample. The CCCM model parameters are (k_{C}, K_{N}, k_{S}, k_{W}, K_{E}, α, β). Similar to the CCLM, these parameters can be estimated by minimizing the sum of squared errors. This model's error can be formulated as follows:

$$E ( n ) = {c}_{ref} ( n ) - ( {y}_{ref} ( n ) * K + α \cdot P ( {{y}_{ref} ( n )}^{2} ) + β \cdot b ) , n ∈ 1 : N , \qquad ( 6 )$$

where, a pair of y_{ref}(n) and c_{ref}(n) indicates, respectively, a reference luma sample and a corresponding reference chroma sample, indexed by n∈1:N. And, where a pair of y_{ref}(n) and c_{ref}(n) reference samples are derived, respectively, from reconstructed luma and chroma samples that are in the vicinity of the CU for which the prediction is performed (according to (5)). Hence, a least-squares optimization algorithm can be used to find the optimal values for the model's parameters (k_{C}, k_{N}, k_{S}, k_{W}, K_{E}, α, β) that minimize the sum of squared errors

$$E = {\sum }_{n = 1}^{N} {E ( n )}^{2} .$$

The N reference pairs y_{ref}(n) and c_{ref}(n) can be selected from a reference area, as further explained with reference to FIG. 4.

The prediction of a chroma sample according to CCCM (as formulated in equation (5)) can be expressed as follows:

$${C}_{p}^{CCCM} ( i , j ) = {s}^{T} \cdot Φ , \qquad ( 7 )$$

where, the (·) and the T operators represent, respectively, a dot product and a matrix transpose operation; φ=(φ₀, φ₁, φ₂, φ₃, φ₄, φ₅, φ₆)=(k_{C}, k_{N}, k_{S}, k_{W},k_{E}, α, β) is a column vector containing the CCCM model's parameters; and s=[Yᵣₛ(i,j), Yᵣₛ(i,j−1), Yᵣₛ(i,j+1), Yᵣₛ(i−1,j), Yᵣₛ(i+1,j), p, b] is a column vector, namely, an observation vector. Note that both vectors φ and s have the same dimension, denoted by M.

As explained above, the parameter vector φ can be estimated by minimizing the model's sum of squared errors. The model's error can be expressed as follows:

$$E ( n ) = {c}_{ref} ( n ) - {{s}_{ref} ( n )}^{T} \cdot Φ , n ∈ 1 : N , \qquad ( 8 )$$

where n indexes a location (i,j) within the used reference area, and so s_{ref}(n)=[yᵣₛ(i,j),yᵣₛ(i,j−1),yᵣₛ(i,j+1),yᵣₛ(i−1,j),yᵣₛ(i+1,j), p,b] and c_{ref}(n)=c_{ref}(i,j). Thus, the optimal value for φ that minimizes the sum of squared errors

$$E = {\sum }_{n = 1}^{N} {E ( n )}^{2}$$

can be derived by:

$$Φ = {( S \cdot {S}^{T} )}^{- 1} \cdot S \cdot {C}_{ref} = {A}^{- 1} \cdot B \qquad ( 9 )$$

where, S=[s(1), s(2), . . . , s(N)] is a matrix of M by N dimension, and c_{ref}=[c_{ref}(1), c_{ref}(2), . . . , c_{ref}(N)] is a column vector of N dimension. Note that the matrix A≡(S·S^{T}) is an auto-correlation matrix of M by M dimension and the vector B≡S·C_{ref} is a cross-correlation vector of dimension M.

Hence, the elements of the autocorrelation matrix can be computed by:

$${A}_{k , l} = {\sum }_{n = 1}^{N} {s}_{k} ( n ) \cdot {s}_{l} ( n ) , \qquad ( 10 )$$

and the elements of the cross-correlation vector can be computed by:

$${B}_{k} = {\sum }_{n = 1}^{N} {s}_{k} ( n ) \cdot {C}_{ref} ( n ) , \qquad ( 11 )$$

where, the observation vector s(n) is associated with a reference sample (i,j) that is indexed by n. The elements of an observation vector s(n) are referred to herein by: sₖ=φ(n)=yᵣₛ(i,j), sₖ=1(n)=yᵣₛ(i,j−1), sₖ=2(n)=yᵣₛ(i,j+1), and so on.

As shown in equation (9), to derive the model's parameter vector φ the autocorrelation matrix A has to be inverted. For example, the autocorrelation matrix can be decomposed according to an LDL^{T} decomposition and the parameter vector φ can then be computed using back-substitution. Generally, this process follows adaptive loop filtering (ALF) when ECM is used (see, M. Coban, et al., “Algorithm description of Enhanced Compression Model 7 (ECM 7),” document JVET-AB2025, 28th Meeting, by teleconference, October 2022). LDL^{T} decomposition (also known as alternative Cholesky decomposition) is used instead of Cholesky decomposition to avoid using square root operations. In another variant, a Gaussian elimination technique can be used to invert the autocorrelation matrix (see, J. Lainema, et al., “AHG12: Simplified linear model solver,” document JVET-AC0053, 29th Meeting, by teleconference, 11-20 Jan. 2023). When ECM is used, the autocorrelation matrix inversion computation uses integer 64-bits arithmetic.

Yet another model for a CC-based prediction is the GL-CCCM. In this model gradient information and location information are used for prediction (see, RG. Youlavari, et al., “EE2-1.12: Gradient and location based convolutional cross-component model (GL-CCCM) for intra prediction,” document JVET-AC0054, 29th Meeting, by teleconference, 11-20 Jan. 2023). Hence, the GL-CCCM can be expressed as follows:

$${C}_{p}^{GL - CCM} ( i , j ) = {s}^{T} \cdot Φ , \qquad ( 12 )$$

where, s=[Yᵣₛ(i,j), Gₓ(i,j), G_{y}(i,j), i, j, p, b] is a column vector formed based on luma samples associated with location (i,j) and φ=(φ₀, φ₁, φ₂, φ₃, φ₄, φ₅, φ₆) is a column vector containing the GL-CCCM model's parameters. The dimension of both vectors s and φ is denoted by M. The (·) and T operators represent, respectively, a dot product and a matrix transpose operation. The gradients, Gₓ(i,j) and G_{y}(i,j), can be derived as follows:

$${G}_{x} ( i , j ) = ( 2 \cdot {Y}_{rs} ( i - 1 , j ) + {Y}_{rs} ( i - 1 , j - 1 ) + {Y}_{rs} ( i - 1 , j + 1 ) ) - ( 2 \cdot {Y}_{rs} ( i + 1 , j ) + {Y}_{rs} ( i + 1 , j - 1 ) + {Y}_{rs} ( i + 1 , j + 1 ) ) \qquad ( 13 )$$

$$and$$

$${G}_{y} ( i , j ) = ( 2 \cdot {Y}_{rs} ( i , j - 1 ) + {Y}_{rs} ( i - 1 , j - 1 ) + {Y}_{rs} ( i + 1 , j - 1 ) ) - ( 2 \cdot {Y}_{rs} ( i , j + 1 ) + {Y}_{rs} ( i - 1 , j + 1 ) + {Y}_{rs} ( i + 1 , j + 1 ) ) . \qquad ( 14 )$$

As with respect to CCCM, the parameter vector φ of GL-CCCM can be computed according to equations (9)-(11), obtained by minimizing the sum of squared errors.

FIG. 4 is a diagram illustrating reference areas used for a CC-based prediction. In the example of FIG. 4, luma samples 400A and corresponding (subsampled) chroma samples 400B are shown. A luma block (e.g., from a CU or a partition thereof) and its corresponding chroma block are indicated by dark grey squares. A reference luma area, including reference luma samples y_{ref}(n), and a corresponding reference chroma area, including reference chroma samples c_{ref}(n), are indicated by white squares. Corresponding samples from the reference luma area and the reference chroma area can be used to compute the parameters of any of the above described models (e.g., CCLM, CCCM, or GL-CCCM). Thus, reference luma samples y_{ref}(n) and their corresponding reference chroma samples c_{ref}(n) can be selected from the respective reference areas. Since, the chroma content 400B is subsampled relative to the luma content 400A (for example when using a 4:2:0 format), a chroma sample corresponds to a luma sample that may be derived (or interpolated) from the luma content of four luma samples (e.g., the four luma samples indicated by the dotted squares in 400A are down-sampled into a luma sample that corresponds to the chroma sample indicated by the dotted square in 400B).

As shown in FIG. 4, three regions can be delineated within both the luma reference area and the chroma reference area: denoted R₁, R₂, and R₃. In an aspect, the reference samples may be selected from a region signaled explicitly in the bitstream (e.g., at the CU level). For example, the reference chroma and luma samples may be selected from regions R₁, R₂, R₃, or a combination thereof. An extended area (e.g., the samples indicated by light grey squares) may also be used to support filtering of the reference luma and chroma samples (white squares) located along the boundary of the luma and the chroma reference areas. For each luma and corresponding chroma blocks, a reference area is determined that includes reconstructed samples; however, if reconstructed samples are not available, padding may be applied. For example, the extended area can be used to support a convolution by the 3×3 kernel K (see, equation (3)), and if samples in this extended area are not available, they can be extrapolated from available reconstructed samples or they can be padded with zeros.

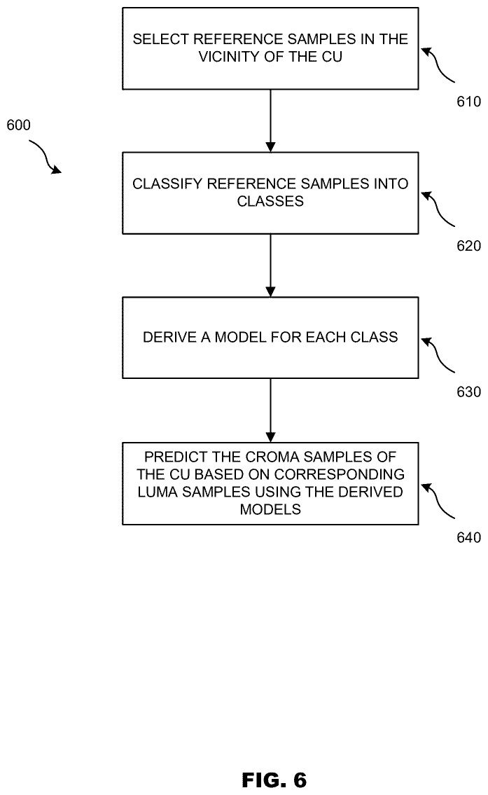

FIG. 5 is a diagram illustrating a multi-model CC-based prediction 500. A multi-model prediction may be used with models such as those described herein (e.g., CCLM, CCCM, GL-CCCM, or a combination thereof). When a multi-model predictor is applied, the N reference pairs (y_{ref}(n), c_{ref}(n)) that are used to derive the model's parameters are first classified into multiple classes. The classification may be based on a feature space (e.g., including a feature representing a luma sample's intensity level) that characterizes the reference luma samples y_{ref}(n) and/or the reference chroma samples c_{ref}(n). For example, in the case of two classes, class A 510 and class B 520, the reference pairs (y_{ref}(n), c_{ref}(n)) can be divided into two groups based on a threshold T 530. This threshold T can be determined, for example, based on the average of the pixel intensity levels of the N luma samples y_{ref}(n). As illustrated in FIG. 5, samples that are below (or equal to) the threshold are classified in a first class 510 (denoted by dark circles) and samples that are above the threshold are classified in a second class 520 (denoted by hollow circles). The model associated with each class can be derived (e.g., as described above with respect to equation (9)) based on the reference pairs within each class-resulting in a first model with a parameter vector DA that is derived based on reference pairs from class A 510 and a second model with a parameter vector op that is derived based on reference pairs from class B 520. Accordingly, the first model can be used to predict a chroma sample with a corresponding luma sample that belongs to class A 510 and the second model can be used to predict a chroma sample with a corresponding luma sample that belongs to class B 520. A multi-model CC-based prediction, using any of the models described herein for each of any number of classes, is generally described in reference to FIG. 6.

FIG. 6 is a flowchart for an example method for a CC-based prediction 600. The CC-based prediction method 600 predicts chroma samples of a CU (or a partition thereof) based on corresponding luma samples of the reconstructed and (potentially) subsampled luma samples of the CU. The method 600 begins, in step 610, by selecting reference samples—for example, N reference pairs y_{ref}(n) and c_{ref}(n) may be selected from respective reference areas (reference pairs from regions R₁, R₂, and R₃, or a combination thereof), as described in reference to FIG. 4. In step 620, the reference samples are classified into multiple classes, if a multi-model prediction is applied, as described in reference to FIG. 5. If a single model prediction is applied, step 620 can be skipped, and all reference samples are considered as belonging to the same class. In step 630, a model is derived with respect to each class. Accordingly, for each model of a class, the model's parameter vector φ is derived based on the reference samples from the respective class. Then, in step 640, a chroma sample of the CU can be predicted based on a corresponding luma sample using the model (derived in step 630) that is associated with the class that the corresponding luma sample belongs to.

Generally, the reference samples may be classified into Q classes. Such a classification may be based on features extracted from the luma samples and/or the chroma samples within the reference area. Respective models may be derived for the Q classes, resulting in respective parameter vectors {φ_{q}: q=1, . . . , Q}. Each parameter vector φ_{q} is used to predict a chroma sample based on a corresponding luma sample that belongs to its associated class q. An encoder 200, when performing a CC-based prediction, may be configured to select whether to apply a single model prediction (e.g., using a parameter vector do) or whether to apply a multi-model prediction (e.g., using parameter vectors {φq:q=1, . . . , Q}).

As explained above, the reconstructed luma component Yᵣ is down-sampled to match the lower resolution of the chroma component C, forming the down-sampled reconstructed luma component Yᵣₛ. However, the down-sampling can be avoided by directly using the reconstructed luma component Yᵣ, as proposed by H. J. Jhu, et al., “EE2-1.13 and 1.14: CCCM using non-downsampled luma samples,” document JVET-AC0147, 29th Meeting, by teleconference, 11-20 Jan. 2023). In this case, the observation vector s (associated with a chroma sample at location (i,j) in the chroma component C and with a corresponding luma sample at location (x,y) in the reconstructed luma component Yᵣ) can be expressed as:

$$s = [ {Y}_{r} ( x , y ) , {L}_{0} , {L}_{1} , {L}_{2} , {L}_{3} , {L}_{4} , {L}_{5} , {p}_{0} , {p}_{1} , {p}_{2} , {p}_{4} , b ] , \qquad ( 15 )$$

where L₀=Yᵣ(x−2,y−1), L₁=Y+(x,y−1), L₂=Yᵣ(x+2,y−1), L₃=Yᵣ(x−2,y+1), L₄=Yᵣ(x,y+1), and L₅=Yᵣ(x+2,y+1). Elements p₀, p₁, p₂, p₄ represent a non-linear function of L₀, L₁, L₂, L₄, respectively. And the bias term b can be determined as the middle chroma value (e.g., 512 for 10-bit content). Note that this model has 12 parameters q=(φ₀, φ₁, φ₂, φ₃, φ₄, φ₅, φ₆, φ₇, φ₈, φ₉, φ₁₀, φ₁₁).

Alternatively, down-sampling filters can be applied to the reconstructed luma component Yᵣ to obtain a model for the CC-based prediction. The model can be signaled at the CU level, for example. An observation vector s_{Mi}, associated with a model Mi, can be used for CC-based prediction of a chroma sample at location (i,j), that is,

$${C}_{p} ( i , j ) = {s}_{M i}^{T} \cdot ϕ ,$$

as explained above. The following models are proposed in Y. Chang, et al., “Non-EE2: CCCM using multiple down-sampling filters,” 29th Meeting, by teleconference, 11-20 Jan. 2023 (“Chang”):

$${s}_{M 1} = [ H ( x , y ) , {G}_{1} ( x , y ) , {G}_{2} ( x , y ) , {G}_{3} ( x , y ) , {G}_{4} ( x , y ) , p , b ] , \qquad ( 16 )$$

$${s}_{M 2} = [ H ( x , y ) , H ( x - 1 , y ) , H ( x + 1 , y ) , \\ {G}_{1} ( x , y ) , {G}_{1} ( x - 1 , y ) , {G}_{1} ( x + 1 , y ) , b ] , \qquad ( 17 )$$

$${s}_{M 3} = [ H ( x , y ) , H ( x , y - 1 ) , H ( x , y + 1 ) , \\ {G}_{2} ( x , y ) , {G}_{2} ( x , y - 1 ) , {G}_{2} ( x , y + 1 ) , b ] , and \qquad ( 18 )$$

$${s}_{M 4} = [ H ( x , y ) , H ( x + 1 , y - 1 ) , H ( x - 1 , y + 1 ) , \\ {G}_{4} ( x , y ) , {G}_{4} ( x + 1 , y - 1 ) , {G}_{4} ( x - 1 , y + 1 ) , b ] , \qquad ( 19 )$$

Where an observation vector s_{Mi} is associated with a chroma sample at location (i,j) in C that corresponds to a luma sample at location (x,y) in Yᵣ. And where H(·), G₁(·), G₂(·), G₃(·), and G₄(·) are kernels of the down-sampling filters (proposed in Chang) that are applied to the luma samples. For example, with respect to the application of filter H(x,y), the kernel H(·) is centered at location (x,y) in Yᵣ. Likewise, with respect to the application of filter G₄ (x−1,y+1), the kernel G₄ (·) is centered at location (x−1,y+1) in Yᵣ. Each of these models has 7 parameters Q=(φ₀, φ₁, φ₂, φ₃, φ₄, φ₅, φ₆, φ₇), as do other variants such as CCCM and GL-CCCM.

The computational complexity of deriving a model and then applying it for the prediction of chroma samples depends on the model's number of parameters. The CCCM and the other variants described above use a parameter vector φ of dimension M≥7. As shown above, the derivation of the parameter vector φ and its application require solving a linear system of dimension M that involves an auto-correlation matrix A of dimension M by M and a cross-correlation vector B of dimension M. These computations include constructing A and B (see equations (10)-(11)), inverting matrix A (see equation (9)), multiplying the inverted matrix A⁻¹ with vector B to obtain the model parameter vector φ(see equation (9)), and multiplying φ with the observation vector s to obtain the predicted chroma samples (see equation (7)). These operations require multiple memory access to both chroma and luma samples (that may significantly increase with the number of reference samples used to compute the model d). Complexity is, therefore, not negligible and increases with the number of parameters M.

According to aspects described herein, the CC-based prediction operation is simplified by using a model that is computed based on one luma sample and a gradient of that luma sample. Applying such a model involves the solution of a linear system of dimension M=4 (instead of solving a linear system of dimension M=7). Thus, according to aspects, an optical flow is used for the CC-based prediction of a chroma sample. In addition, the local luma-chroma phase—that is, the spatial phase between corresponding luma and chroma samples—is taken under consideration. For more information about a luma-chroma phase (referred to herein also as a chroma phase), see Application No. EP 23305427.9, filed on Mar. 28, 2023, titled “Phase-Based Motion Compensation for Predictive Video Coding of Chroma Content,” the content of which is incorporated herein by reference in its entirety.

Hence, aspects of a phase-based model are disclosed herein. The phase-based model takes into account a local chroma phase, that is, a spatial phase between the locations of corresponding chroma and luma samples. Accordingly, the prediction of a chroma sample at location (i,j), C(i,j), is computed based on a corresponding luma sample at location (x,y), Yᵣ(x,y), as follows:

$${C}_{p} ( i , j ) = γ \cdot {Y}_{r} ( x + {D}_{x} , y + {D}_{y} ) + β , \qquad ( 20 )$$

where Dₓ and D_{y} are phase parameters representing a spatial adjustment that improves the correspondence between chroma content at location (i,j) and luma content at location (x,y); and so, chroma sample C(i,j) has a better correspondence to luma sample at the adjusted location (x+Dₓ,y+Dy). Parameters γ and β linearly link the predicted chroma sample Cₚ(i,j) to the corresponding luma content provided by Yᵣ(x+Dₓ,y+D_{y}). Notice that the chroma phase (Dₓ,D_{y}) is a local value and may therefore vary throughout the picture.

In equation (20) the relative luma location (x,y) in the reconstructed luma component Yᵣ is considered as being collocated to the relative chroma location (i,j) in the chroma component C. Typically, the location (x,y) depends on the used chroma format (e.g., 4:2:0, 4:2:2, or 4:4:4), and, therefore, on the respective dimensions of the luma and chroma pictures. When luma and chroma samples are not at same resolution, or when luma samples are not aligned with chroma samples positions, it may be needed to interpolate the luma value for Yᵣ(x,y) from luma samples aligned with integer locations neighboring the location (x,y) in the luma picture.

Accordingly, in practice, the value for Yᵣ(x+Dₓ,y+D_{y}) has to be interpolated from luma samples located at integer locations in the vicinity of location (x+Dₓ,y+D_{y}). To avoid interpolation due to the translation by the chroma phase, optical flow can be used. Thus, equation (20) can be approximated as follows:

$${Y}_{r} ( x + {D}_{x} , y + {D}_{y} ) \approx {Y}_{r} ( x , y ) + {D}_{x} \cdot {G}_{x} ( x , y ) + {D}_{y} \cdot {G}_{y} ( x , y ) , \qquad ( 21 )$$

where Gₓ(x,y) and G_{y}(x,y) are the horizontal and vertical gradients of Yᵣ at location (x,y). The gradients may be computed, for example, as Gₓ(x,y)=Yᵣ(x,y)−Yᵣ(x−1,y) and G_{y}(x,y)=Y+(x,y)−Yᵣ(x,y−1), or as Gₓ(x,y)=Y+(x+1,y)−Yᵣ(x,y) and G_{y}(x,y)=Y+(x,y+1)−Yᵣ(x,y), or as described in equations (13) and (14).

The prediction of a chroma sample C(i,j) can then be computed based on the corresponding luma sample Yᵣ(x,y), as follows:

$${C}_{p} ( i , j ) = γ \cdot {Y}_{r} ( x , y ) + δ \cdot {G}_{x} ( x , y ) + ε \cdot {G}_{y} ( x , y ) + β , \qquad ( 22 )$$

where, δ=γ·Dₓ and ε=y·D_{y}. Thus, in this case, the parameter vector is φ=(γ, δ, ε, β) and the observation vector is s=[Yᵣ(x,y), Gₓ(x,y), G_{y}(x,y), 1]. The parameter vector φ can be determined by minimizing the sum of squared errors (e.g., as described with respect to equations (8)-(11)). Thus, prediction according to equation (22) requires solving a linear system of dimension M=4, typically less complex than a prediction based on CCCM that involves solving a linear system of dimension M=7. Specifically, the prediction according to equation (22) involves inversion of an auto-correlation matrix A of 4 by 4 dimension instead of an auto-correlation matrix A of 7 by 7 dimension (see equation (9)).

In a variant, the prediction of a chroma sample can be expressed as follows:

$${C}_{p} ( i , j ) = γ \cdot {Y}_{r} ( x , y ) + δ \cdot {G}_{x} ( x , y ) + ε \cdot {G}_{y} ( x , y ) + β \cdot b , \qquad ( 23 )$$

where, b is a bias term that can be determined as the middle chroma value (e.g., 512 for 10-bit content). Thus, in this case, the parameter vector is φ=(γ, δ, ε, β) and the observation vector is s=[Y+(x,y), Gₓ(x,y), G_{y}(x,y), b].

In yet another variant, a nonlinear term p can be added as follows:

$${C}_{p} ( i , j ) = γ \cdot {Y}_{r} ( x , y ) + δ \cdot {G}_{x} ( x , y ) + ε \cdot {G}_{y} ( x , y ) + α \cdot p + β \cdot b , \qquad ( 24 )$$

wherein, the term p can represent a nonlinear function of the luma sample Yᵣ(x,y) that is scaled to the used bit depth. For example, for a bit depth of 10 bits, the nonlinear term p can be (Y+(x,y)²+512)»10. Thus, in this case, the parameter vector is φ=(γ, δ, ε, α, β) and the observation vector is s=[Yᵣ(x,y), Gₓ(x,y), G_{y}(x,y), p, b]. Note that applying this model requires solving a linear system of dimension M=5, still less computationally complex compared to solving a linear system of dimension M≥7.

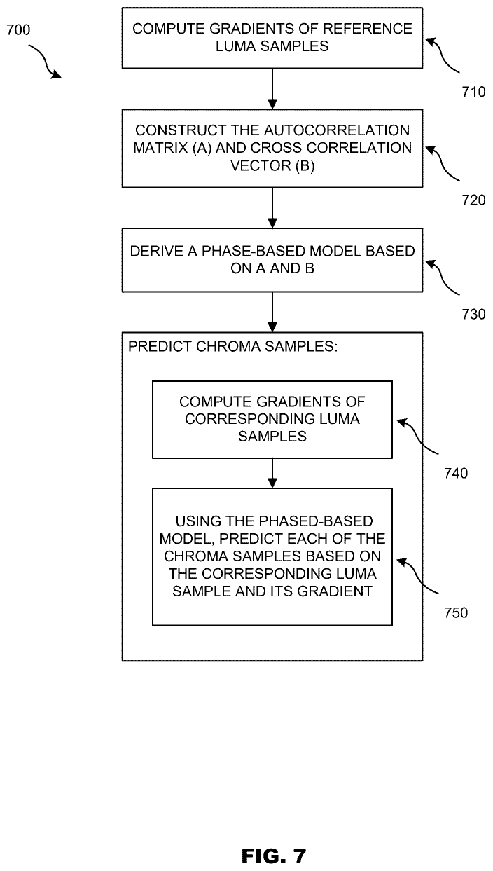

FIG. 7 is a flowchart illustrating the application of a phase-based model to CC-based prediction 700. In the example of FIG. 7, the method 700, in step 710, begins by computing respective gradients, G(x,y)=(Gₓ(x,y), G_{y}(x,y)), of reference luma samples located at respective locations (x,y) within a reference luma area (e.g., the area indicated by white squares in 400A of FIG. 4) in the vicinity of the chroma samples to be predicted (e.g., dark grey squares in 400B of FIG. 4). Based on these gradients, observation vectors can be formed with respect to each of the reference luma samples. For example, the observation vector can be formed according to equation (22) (where s=[Y+(x,y), Gₓ(x,y), G_{y}(x,y), 1]), or according to equation (23) (where s=[Yᵣ(x,y), Gₓ(x,y), G_{y}(x,y), b]), or according to equation (24) (where s=[Yᵣ(x,y), Gₓ(x,y), G_{y}(x,y), p, b]). Next, in step 720, the auto-correlation matrix A and the cross-correlation vector B are constructed based on the observation vectors and based on reference chroma samples within a reference chroma area (e.g., the area indicated by white squares in 400B of FIG. 4), as shown above by equations (10) and (11). A phase-based model can then be derived, in step 730. To that end, the model parameters are computed as φ=A⁻¹·B, following an inversion of the auto-correlation matrix, as shown above by equation (9). The method 700 proceeds in steps 740 and 750 to perform CC-based prediction of the chroma samples (e.g., dark grey squares in 400B of FIG. 4). First, for each of the chroma samples to be predicted, the gradient, G(x,y)=(Gₓ(x,y), G_{y}(x,y)), of the corresponding luma sample at location (x,y) is computed. Based on these gradients, observation vectors can be formed with respect to each chroma sample to be predicted. Then, the phase-based model (derived in step 730) can be applied for the prediction of each of the chroma samples, according to equation (22), (23) or (24).

In another aspect, when a 4:2:0 format is used, equation (22) can be revised as follows:

$${C}_{p r e a} ( i , j ) = γ \cdot {Y}_{r} ( 2 i , 2 j ) + δ \cdot {G}_{x} ( 2 i , 2 j ) + ε \cdot {G}_{y} ( 2 i , 2 j ) + β , \qquad ( 25 )$$

Note that, advantageously, the gradients need to be computed only at locations (2i,2j) of the luma content (in the reference area during model derivation and in the current luma block during model application) and so there is no need to interpolate a luma sample at a sub-pel positions. The process is therefore very simple compared to, for example, CCLM were luma content Yᵣ has to be down-sampled into Yᵣₛ using an interpolation process.

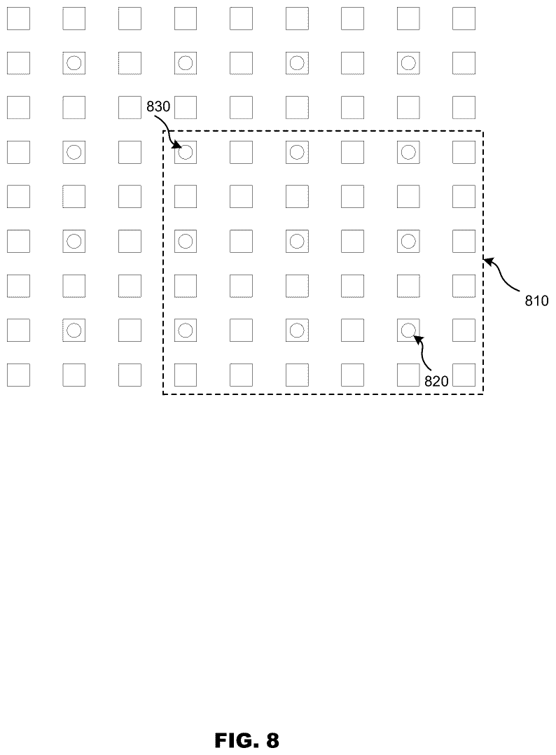

Note that when using a 4:2:0 format, there are no issues at the block boundaries relating to deriving the gradients of luma samples Gₓ and G_{y} if the gradients are derived from surrounding samples of the luma sample. This is illustrated in FIG. 8 that shows the typical relative positions of luma samples (indicated by squares) and of chroma samples (indicated by circles) in a current video block 810. For example, the boundary chroma sample 820 at bottom-right corner of block 810 has a collocated luma sample that is one pixel horizontally and vertically inside the luma block 810, which means that Yᵣ(i+1,j+1) is inside the block 820 and is available for the computation of the gradient at that location 820. Similarly, for the boundary chroma sample 830 at the top-left corner of block 810, Yᵣ(i−1,j−1) is inside the reference area and is available for the computation of the gradient at that location 830. To compute the gradient of luma samples in the reference area, it may be necessary to have at least 3 lines and 3 rows (as shown in FIG. 8) of reconstructed luma samples. Otherwise, interpolation of luma values may be required for non-available samples locations.

In yet another aspect, the parameters of the phase-based model can be derived in multiple stages where, in each stage, only a subset of the parameters is computed. This approach may further reduce the number of operations needed to derive the model 730. A process for deriving the parameters of the phase-based model in two stages is demonstrated below.

In a first stage, a first subset of the parameters is computed. In this stage, a reduced version of the phase-based model is considered. For example, with respect to the phase-based model of equation (22), only parameters γ and β are considered, reducing the model as follows:

$${C}_{p}^{1} ( i , j ) = γ \cdot Y ( x , y ) + β . \qquad ( 26 )$$

Thus, parameters γ and β that minimize the sum of squared errors of the reduced model, denoted, \hat{γ} and \hat{β}, can be found. The reduced model's error in this stage can be expressed as:

$$E ( n ) = {c}_{r e f} ( n ) - {C}_{p}^{1} ( n ) , n ∈ 1 : N , \qquad ( 27 )$$

where n indexes locations (i,j) of reference chroma samples (e.g., white squares in 400B of FIG. 4) and their corresponding reference luma samples (e.g., derived from white squares in 400A of FIG. 4).

In a second stage, a second subset, including the remaining of the model parameters, is computed. Thus, in this example, the remaining parameters δ and ε are considered, as follows:

$${C}_{p}^{2} ( i , j ) = \hat{γ} \cdot Y ( x , y ) + δ \cdot {G}_{x} ( x , y ) + ε \cdot {G}_{y} ( x , y ) + \hat{β} . \qquad ( 28 )$$

Next, the second parameter subset, including parameters δ and ε, that minimizes the model's sum of squared errors can be found. The model's error in this stage can be expressed as:

$$E ( n ) = {c}_{r e f} ( n ) - {C}_{p}^{2} ( n ) , n ∈ 1 : N , \qquad ( 29 )$$

where, as before, n indexes locations (i,j) of reference chroma samples and their corresponding reference luma samples.

A least-squares optimization algorithm can be used to find the optimal values for the first parameter subset (in the first stage) and for the second parameter subset (in the second stage) that minimize the respective sum of squared errors

$$E = {\sum }_{n = 1}^{N} {E ( n )}^{2} .$$

In an aspect, in the second stage, an optimization constraint can be added that limits the maximum phase values Dx and Dy. Thus, in the second stage, limiting the maximum phase values provides an optimization constraint with respect to the values of parameters: δ=\hat{γ}·Dₓ and ε=\hat{γ}·D_{y}. For example, a clipping of the values of δ and ε can be applied after the estimation of these parameters using a predetermined range for Dₓ and D_{y}. For instance, given a predetermined range between −4 to 4 pixels, the clipping of the values of estimated parameter \hat{δ} and \hat{ε} may be applied as follows:

$${\hat{δ}}_{clipped} = min ( max ( \hat{δ} , - 4 \cdot \hat{γ} ) , 4 \cdot \hat{γ} ) , \qquad ( 30 )$$

$${\hat{ε}}_{clipped} = min ( max ( \hat{ε} , - 4 \cdot \hat{γ} ) , 4 \cdot \hat{γ} ) , \qquad ( 31 )$$

The limits on the phase values Dx and Dy can also be used in the general case involving a single stage for deriving the parameters (γ, δ, ε, β) (or parameters (γ, δ, ε, α, β)). In this case, the computation of the phase-based model's parameters can be constrained based on a predetermined range for the chroma-phase. In an aspect, first, the estimation of these parameters is performed, then, the estimated values for parameters δ and ε may be clipped using the given range for Dₓ and D_{y}, for example, according to equations (30) and (31).

FIG. 9 is a flowchart for an example method for encoding a chroma sample 900, according to which aspects of the present embodiments can be implemented. The method 900, in step 910, obtain video data, including luma and chroma samples. Then, in steps 920 and 930, a chroma sample, obtained by the method 900, is intra-encoded using a CC-based prediction. To that end, in step 920, a phase-based model is derived. The phase-based model is a function of a corresponding luma sample, a gradient, and a chroma phase. The gradient can represent a vertical gradient value and a horizontal gradient value at a location of the corresponding luma sample. The chroma phase represents a spatial phase between a location of the chroma sample and a location of the corresponding luma sample. Once the phase-based model is derived, in step 930, the chroma sample can be predicted using the derived phase-based model.

The phase-based model includes parameters associated with the corresponding luma sample and its gradient. In an aspect, the phase-based model further includes a parameter associated with a bias term. In a further aspect, the phase-based model further includes a parameter associated with a non-linear function of the corresponding luma sample. The parameters of the phase-based model may be computed in multiple stages. In a first stage, a first subset of the parameters can be determined using a reduced version of the phase-based model, and, in a second stage, a second subset of the parameters can be determined based on the parameters in the first subset, using the phase-based model. In an aspect, the computation of the parameters can be constrained based on a predetermined range for the chroma-phase (e.g., by setting a maximum value for one or more parameters that are associated with a chroma phase value).

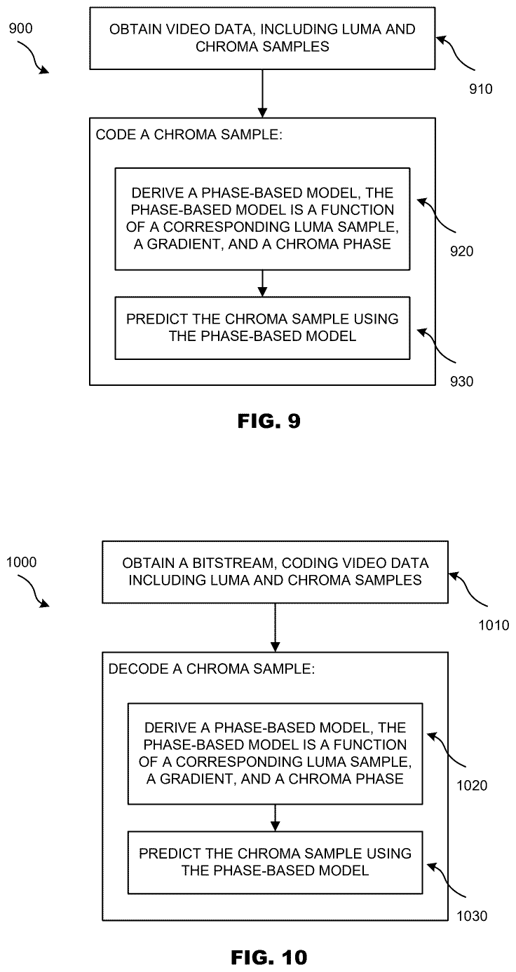

FIG. 10 is a flowchart for an example method for decoding a chroma sample 1000, according to which aspects of the present embodiments can be implemented. The method 1000, in step 1010, obtains a bitstream that codes video data including luma and chroma samples. Then, in steps 1020 and 1030, a chroma sample, coded in the bitstream, is intra-decoded using a CC-based prediction. To that end, in step 1020, a phase-based model is derived (in the same manner it is derived by the encoder in step 920). Then, in step 1030, the chroma sample is predicted using the derived phase-based model (in the same manner it is predicted by the encoder in step 930).

We have described several aspects and embodiments in the present disclosure. These aspects and embodiments provide at least the following outputs and results, including all combinations, across different claim categories and types:
Encoding, into coded video data, syntax elements that can enable the decoder to decode the coded video data, according to any of the aspects described herein.
A bitstream that includes one or more of the described syntax elements, or variations thereof. A bitstream can be any set of data whether transmitted, stored, or otherwise made available.
Creating, transmitting, receiving, and/or decoding of the bitstream.
An electronic device (e.g., a TV, a set-top box, a cell phone, or a tablet) that tunes (e.g., using a tuner) a channel to receive the bitstream or that receives (e.g., using an antenna) the bitstream over the air. The electronic device decodes the syntax elements from the bitstream, and, optionally, displays (e.g., using a monitor, screen, or any other type of display) a resulting image.

Various other generalized, as well as particularized, outputs, results, implementations, and claims are also supported and contemplated throughout this disclosure.

Various methods are described herein, and each of the methods comprises one or more steps or actions for achieving the described method. Unless a specific order of steps or actions is required for the proper operation of the method, the order and/or use of specific steps and/or actions can be modified or combined. Additionally, terms such as “first”, “second”, etc. can be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

Various methods and other aspects described in this application can be used to modify modules, for example, the modules of the video encoder 200 and the video decoder 300 as shown in FIG. 2 and FIG. 3. Moreover, the present aspects are not limited to a specific standard (such as VVC or HEVC) and can be applied, for example, to other standards and recommendations, as well as extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video data in order to produce an encoded bitstream. Additionally, the terms “reconstructed” and “decoded” can be used interchangeably, the terms “encoded” or “coded” can be used interchangeably, and the terms “image,” “picture,” and “frame” can be used interchangeably. Usually, but not necessarily, the term “reconstructed” is used on the encoder side while the term “decoded” is used on the decoder side.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including, for example, manners that are common in video standards such as putting the information into an SPS, a PPS, a NAL unit, a header (for example, a NAL unit header, or a slice header), or an SEI message. Other manners are also available, including, for example, manners common for system level or application level standards such as signaling the information into one or more of the following:
a. SDP (session description protocol), a format for describing multimedia communication sessions for the purposes of session announcement and session invitation, for example, as described in RFCs and used in conjunction with RTP (Real-time Transport Protocol) transmission.
b. DASH MPD (Media Presentation Description) Descriptors, for example, as used in DASH and transmitted over HTTP. A descriptor is associated with a Representation or collection of Representations to provide additional characteristics to the content Representation.
c. RTP header extensions, for example, as used during RTP streaming.
d. ISO Base Media File Format, for example, as used in OMAF and using boxes which are object-oriented building blocks defined by a unique type identifier and length (also known as ‘atoms’ in some specifications).
e. HLS (HTTP live Streaming) manifest transmitted over HTTP. A manifest can be associated, for example, with a version or collection of versions of content to provide the characteristics of the version or collection of versions.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (PDAs), and other devices that facilitate communication of information between end-users.

Reference to “one/an aspect” or “one/an embodiment” or “one/an implementation,” as well as other variations thereof, means that a particular feature, structure, characteristic, and so forth described in connection with the aspect/embodiment/implementation is included in at least one embodiment. Thus, the appearances of the phrase “in one/an aspect” or “in one/an embodiment” or “in one/an implementation,” as well any other variations, appearing in various places throughout this application, are not necessarily all referring to the same embodiment.

Additionally, this application can refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing,” intended to be a broad term. Receiving the information can include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization parameter for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual data, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method comprising:
obtaining video data, including luma and chroma samples; and
coding a chroma sample, the coding comprises:
deriving a phase-based model, wherein the phase-based model is a function of a corresponding luma sample, and of a gradient of the corresponding luma sample, and wherein a parameter of the model, associated with the gradient of the corresponding luma sample, is a product of a respective chroma phase and a parameter of the model associated with the corresponding luma sample, and
predicting the chroma sample using the phase-based model.

2. The method according to claim 1, wherein the gradient represents a vertical gradient value and a horizontal gradient value of the corresponding luma sample.

3. The method according to claim 1, wherein the respective chroma phase represents a spatial phase between a location of the chroma sample and a location of the corresponding luma sample.

4. The method according to claim 1, wherein the phase-based model includes only four parameters including the parameter associated with the corresponding luma sample and parameters associated with the gradient of the corresponding luma sample.

5. The method according to claim 4, wherein the phase-based model further includes a parameter associated with a bias term.

6. The method according to claim 5, wherein the phase-based model further includes a parameter associated with a non-linear function of the corresponding luma sample.

7. The method according to claim 1, wherein the deriving of the phase-based model comprises:
computing parameters of the phase-based model in multiple stages, including:
in a first stage, determining a first subset of the parameters including the parameter of the model associated with the corresponding luma sample, and
in a second stage, determining, based on the parameters in the first subset, a second subset of the parameters including the parameter of the model associated with the gradient of the corresponding luma sample.

8. The method according to claim 7, further comprising:
constraining the computation of the phase-based model parameters by limiting the respective chroma phase to a predetermined range for the chroma phase.

9. The method according to claim 1, wherein the deriving of the phase-based model comprises:
computing parameters of the phase-based model, including constraining the computation of the parameters by limiting the respective chroma phase to a predetermined range for the chroma phase.

10. A method comprising:
obtaining a bitstream, coding video data including luma and chroma samples; and
decoding a chroma sample, the decoding comprises:
deriving a phase-based model, wherein the phase-based model is a function of a corresponding luma sample, and of a gradient of the corresponding luma sample, and wherein a parameter of the model, associated with the gradient of the corresponding luma sample, is a product of a respective chroma phase and a parameter of the model associated with the corresponding luma sample, and
predicting the chroma sample using the phase-based model.

11. The method according to claim 10, wherein the gradient represents a vertical gradient value and a horizontal gradient value of the corresponding luma sample.

12. The method according to claim 10, wherein the respective chroma phase represents a spatial phase between a location of the chroma sample and a location of the corresponding luma sample.

13. The method according to any one of claim 10, wherein the phase-based model includes only four parameters including the parameter associated with the corresponding luma sample and parameters associated with the gradient of the corresponding luma sample.

14. The method according to claim 13, wherein the phase-based model further includes a parameter associated with a bias term.

15. The method according to claim 14, wherein the phase-based model further includes a parameter associated with a non-linear function of the corresponding luma sample.

16. The method according to claim 10, wherein the deriving of the phase-based model comprises:
computing parameters of the phase-based model in multiple stages, including:
in a first stage, determining a first subset of the parameters including the parameter of the model associated with the corresponding luma sample, and
in a second stage, determining, based on the parameters in the first subset, a second subset of the parameters including the parameter of the model associated with the gradient of the corresponding luma sample.

17. The method according to claim 16, further comprising:
constraining the computation of the phase-based model parameters by limiting the respective chroma phase to a predetermined range for the chroma phase.

18. The method according to claim 10, wherein the deriving of the phase-based model comprises:
computing parameters of the phase-based model, including constraining the computation of the parameters by limiting the respective chroma phase to a predetermined range for the chroma phase.

19. An apparatus, comprising:
at least one processor; and
memory storing instructions that, when executed by the at least one processor, cause the apparatus to:
obtain video data, including luma and chroma samples, and
code a chroma sample, the coding comprises:
deriving a phase-based model, wherein the phase-based model is a function of a corresponding luma sample, and of a gradient of the corresponding luma sample, and wherein a parameter of the model, associated with the gradient of the corresponding luma sample, is a product of a respective chroma phase and a parameter of the model associated with the corresponding luma sample, and
predicting the chroma sample using the phase-based model.

20-23. (canceled)

24. An apparatus, comprising:
at least one processor; and
memory storing instructions that, when executed by the at least one processor, cause the apparatus to:
obtain a bitstream, coding video data including luma and chroma samples, and
decode a chroma sample, the decoding comprises:
deriving a phase-based model, wherein the phase-based model is a function of a corresponding luma sample, and of a gradient of the corresponding luma sample, and wherein a parameter of the model, associated with the gradient of the corresponding luma sample, is a product of a respective chroma phase and a parameter of the model associated with the corresponding luma sample, and
predicting the chroma sample using the phase-based model.

25-30. (canceled)
